(19) United States
(12) Patent Application Publication
(10) Pub. No.: US 2006/0232904 A1
(43) Pub. Date: Oct. 19, 2006

(54) Supply voltage independent sensing circuit for electrical fuses

(75) Inventors: Jui-Jen Wu, Hsinchu (TW); Yung-Lung Lin, Hsinchu (TW)

Correspondence Address: Howard Chen;Preston Gates & Ellis LLP, 55 Second Street, Suite 1700, San Francisco, CA, 94105, US

(73) Assignee: Taiwan Semiconductor Manufacturing Co.

(21) Appl. No.: 11/106,303

(22) Filed: Apr. 13, 2005

(51) Int. Cl. H02H 5/04

(52) U.S. Cl. 361/104

(57) ABSTRACT

A sensing circuit is disclosed for sensing a programming state of an electrical fuse, comprising. An electrical fuse is coupled to a supply voltage. A first transistor is serially coupled between the electrical fuse and a complementary supply voltage. An inverter sense amplifier is coupled to a node between the electrical fuse and the first transistor for outputting a logic signal whose value is determined based on a comparison between a resistance of the electrical fuse and a predetermined reference resistance. A bias circuit applies a bias independent of variation of the first voltage to a gate of the first transistor, such that the predetermined reference resistance is substantially insensitive to the variation of the first voltage.

### BACKGROUND

The present invention relates generally to integrated circuit designs, and more particularly to a sensing circuit independent of a supply voltage for electrical fuses.

Electrical fuses are often utilized for modern integrated circuits. They are designed to blow when current flowing through the fuses exceeds a threshold value. Electrical fuses are commonly used for making adjustments and repairs of integrated circuits that may be performed in a packaged chip. The electrical fuses provide the integrated circuits with design flexibility.

A sensing circuit is commonly used to sense a programming state of the electrical fuses before and after it blows. Conventionally, the sensing circuit employs an inverter sense amplifier to sense a voltage drop across an electrical fuse that is serially coupled to an NMOS transistor. The higher the resistance of the electrical fuse, the higher the voltage drop thereacross. Since the resistance of the electrical fuse increases significantly after it blows, the programming state of the electrical fuse can be determined by sensing the voltage drop. For example, before the electrical fuse blows, its resistance is low and the voltage drop is also low. On the other hand, after the electrical fuse blows, its resistance becomes higher and the voltage drop also becomes larger. The voltage drop provides a sensing voltage representing the resistance of the electrical fuse. The inverter sense amplifier receives the sensing voltage and outputs logic “1” or “0,” depending on the resistance of the electrical fuse. The sensing circuit has a predetermined reference resistance. If the resistance of the electrical fuse is higher than the reference resistance, the inverter sense amplifier outputs logic “1,” meaning that the electrical fuse has blown. If the resistance of the electrical fuse is lower than the reference resistance, the inverter sense amplifier outputs logic “0,” meaning that the electrical fuse is intact.

The conventional sensing circuit has certain drawbacks. The inverter sense amplifier used in the sensing circuit can be very sensitive to variation of a supply voltage. When the supply voltage decreases, the reference resistance shifts and becomes less distinguishable. This may cause the inverter sense amplifier misreading the programming state of the electrical fuse. Furthermore, the inverter sense amplifier is also very sensitive to variation of process of fabricating the devices used in the sensing circuit. This may also cause the inverter sense amplifier misreading the electrical fuse.

What is needed is a sensing circuit for electrical fuses that is independent of supply voltage and fabrication process variations.

### SUMMARY

This invention discloses a sensing circuit for sensing a programming state of an electrical fuse. In one embodiment, the sensing circuit includes an electrical fuse, inverter sense amplifier and bias circuit. The electrical fuse is coupled to a first voltage. The first transistor is serially coupled between the electrical fuse and a second voltage that is lower than the first voltage. The inverter sense amplifier is coupled to a node between the electrical fuse and the first transistor for outputting a logic signal whose value is determined based on a comparison between a resistance of the electrical fuse and a predetermined reference resistance. The bias circuit applies a bias independent of variation of the first voltage to a gate of the first transistor, such that the predetermined reference resistance is substantially insensitive to the variation of the first voltage.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 illustrates an ideal relationship between the resistance of an electrical fuse and the sense output of a sensing circuit.

FIG. 2A illustrates a conventional sensing circuit for sensing a programming state of an electrical fuse.

FIG. 2B illustrates the shifting of the reference resistance of the conventional sensing circuit as a supply voltage decreases.

FIG. 3A illustrates a sensing circuit having a bias circuit outputting a substantially constant bias independent of variation of supply voltage in accordance with one embodiment of the present invention.

FIG. 3B illustrates the reference resistance of the conventional sensing circuit as a supply voltage decreases in accordance with one embodiment of the present invention.

### DESCRIPTION

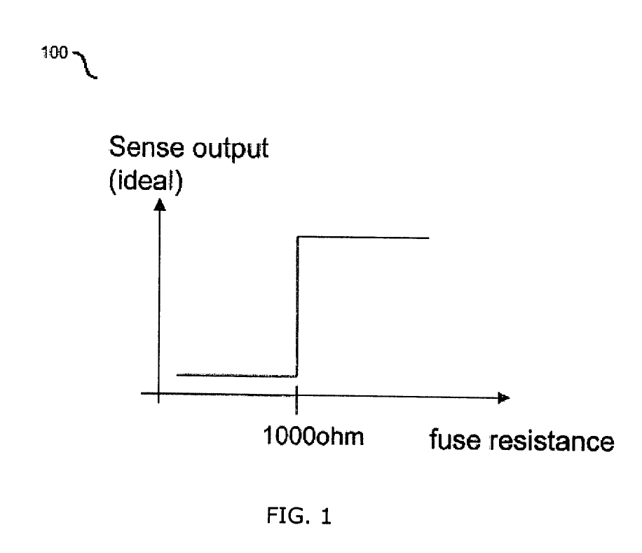

FIG. 1 illustrates a graph 100 showing an ideal relation between the resistance of an electrical fuse and the sense output of a sensing circuit (not shown in the figure). The reference resistance of a sensing circuit is set to 1,000 ohms. If the sensing circuit detects a sense voltage that is caused by an electrical fuse having resistance of 1,000 ohms or more, the sensing circuit outputs a sense output of logic “1.” This indicates that the electrical fuse is blown or programmed. If the sensing circuit detects a sense voltage caused by an electrical fuse having resistance less than 1,000 ohms, the sensing circuit outputs a sense output of logic “0.” This indicates that the electrical fuse is intact and has not been programmed.

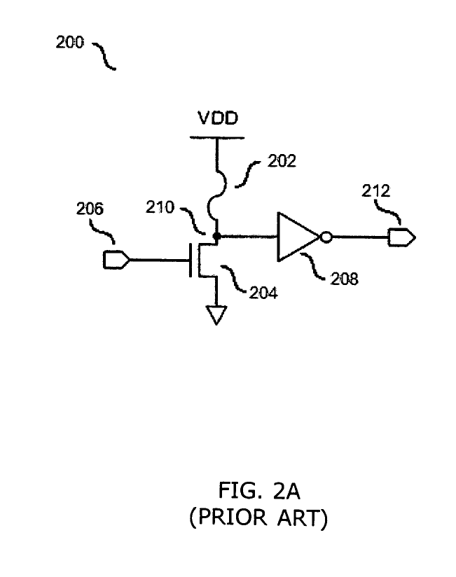

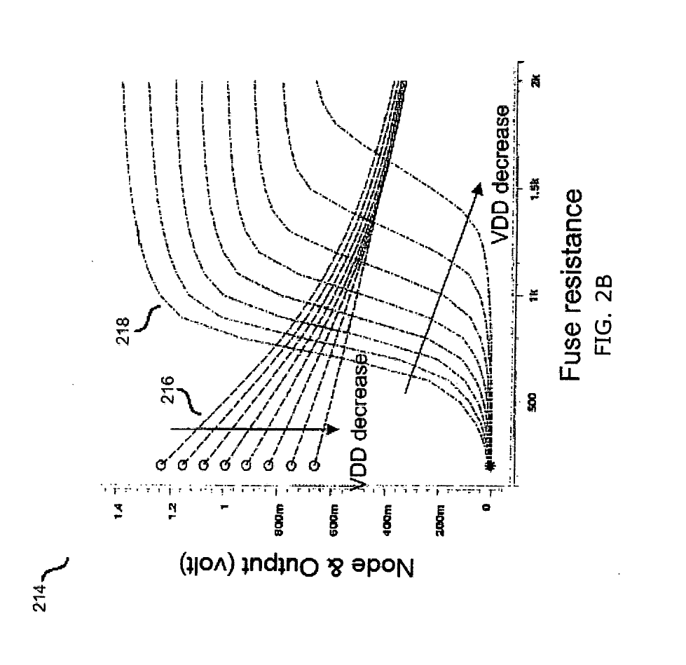

FIG. 2A illustrates a conventional sensing circuit 200. An electrical fuse 202 is connected in series with an NMOS transistor 204 between a supply voltage VDD and ground in a voltage divider configuration. The gate of the NMOS transistor 204 is connected to an input line 206, which is also coupled to a supply voltage VDD. An inverter sense amplifier 208 is connected to a node 210 between the electrical fuse 202 and the NMOS transistor 204. The inverter sense amplifier 208 receives a sense voltage from the node 210, and outputs a sense output signal to an output line 212.

In operation, the serially connected electrical fuse 202 and the NMOS transistor 204 function as a voltage divider. The sense voltage at the node 210 is lower than the supply voltage, and depends on the resistance of the electrical fuse 202 and the transconductance of the NMOS transistor 204. If the electrical fuse 202 is intact and its resistance is low, the sense voltage at the node 210 will be high and the inverter sense amplifier 208 will output logic “0.” If the electrical fuse 202 blows and its resistance is high, the sense voltage at the node 210 will be low and the inverter sense amplifier 208 will output logic “1.” Thus, the outputs of the inverter sense amplifier 208 indicate the programming state of the electrical fuse 202.

Referring to FIGS. 2A and 2B, a graph 214 shows a set of curves 216 and a set of curves 218. The set of curves 216 represent the voltages at the node 210 with various supply voltages. As the supply voltage VDD decreases, the sense voltage at the node 210 decreases, too. The set of curves 218 represent the relations between the resistance of the electrical fuse 202 and the sense output at the output line 212 with various supply voltages. Any given curve of the set 218 includes a logic “0” region, logic “1” region, and a reference resistance region, which is the segment of the curve connecting the upper and lower horizontal lines. The reference resistance represents a benchmark for determining if the electrical fuse 202 is programmed. If the resistance of the electrical fuse 202 is higher than the reference resistance, the sensing circuit 200 outputs logic “1,” or vice versa.

In an ideal case, the reference resistance is represented by a vertical line in FIG. 1. In reality, the reference resistance region is represented by a forward inclined curve as shown in FIG. 2B. It is desirable to have a steep curve representing the reference resistance region as it is closer to an ideal scenario. However, as the supply voltage VDD decreases, the curve segment representing the reference resistance region inclines and the logic “0” region extends to the right. As shown in FIG. 2B, as the supply voltage decreases, the reference voltage increases from about 500 ohms to 1,500 ohms. This may cause the sensing circuit 200 misreading the programming state of the electrical fuse 202. Thus, it is desirable to have a sensing circuit that is independent of variation of supply voltage for sensing the programming state of an electrical fuse.

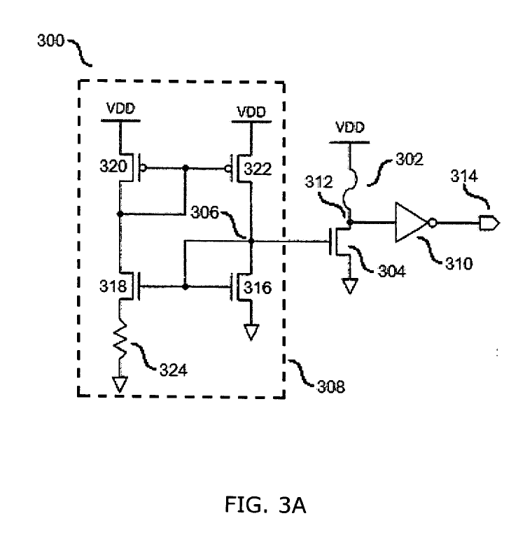

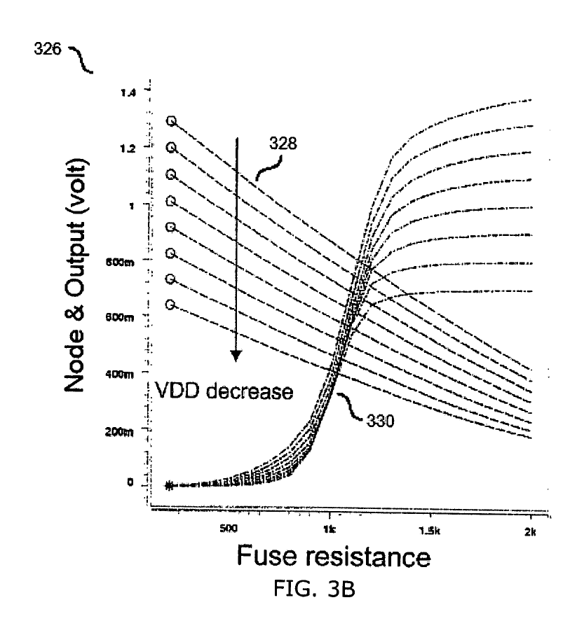

FIG. 3A illustrates a sensing circuit 300 for sensing a programming state of an electrical fuse 302. The electrical fuse 302 is coupled to a supply voltage VDD. An NMOS transistor 304 is serially coupled between the electrical fuse 302 and a complementary supply voltage, such as ground or any voltage lower than the supply voltage. The electrical fuse 302 and the NMOS transistor 304 are connected in a voltage divider configuration. An inverter sense amplifier 310 is connected to a node 312 between the electrical fuse 302 and the NMOS transistor 304. The inverter sense amplifier 310 receives a sense voltage from the node 312, and outputs a sense output signal to an output line 314. The gate of the NMOS transistor 304 is connected to a node 306 of a bias circuit 308, which outputs a bias independent of variation of the supply voltage.

The bias circuit 308 includes PMOS transistors 320 and 322, NMOS transistors 316 and 318, and a resistor 324. The PMOS transistor 322 is coupled to the supply voltage, such as VDD. The NMOS transistor 316 is serially coupled between the PMOS transistor 322 and the complementary supply voltage, such as ground. The node 306 is between the PMOS transistor 322 and the NMOS transistor 316. The PMOS transistor 320 is coupled to the supply voltage having its gate connected to its drain and to the gate of the PMOS transistor 322. The NMOS transistor 318 is serially coupled to the PMOS transistor 320, having its gate connected to the gate and drain of the NMOS transistor 316. The resistor 318 is serially coupled between the NMOS transistor 318 and ground.

In operation, the electrical fuse 302 and the NMOS transistor 304 function as a voltage divider. The sense voltage at the node 312 is lower than the supply voltage, and depends on the resistance of the electrical fuse 302 and the transconductance of the NMOS transistor 304. If the electrical fuse 302 is intact and its resistance is low, the sense voltage at the node 312 will be high and the inverter sense amplifier 310 will output logic “0” to the data line 314. If the electrical fuse 302 blows and its resistance is high, the sense voltage at the node 312 will be low and the inverter sense amplifier 310 will output logic “1” to the data line 314. Thus, the outputs of the inverter sense amplifier 310 indicate the programming state of the electrical fuse 302.

The bias circuit 308 outputs a substantially constant bias independent of variation of the supply voltage. The NMOS transistors 316 and 318 are placed in a current mirror configuration. The PMOS transistors 320 and 322 are designed to provide a substantially constant current though the NMOS transistor 316. The transconductance value of the NMOS transistor 316 is determined by the characteristics of the NMOS transistors 316 and 318, and the resistor 324. Specifically, the transconductance gm1 of the NMOS transistor 316 is as following:
gm1=(2/R324)*(1−sqrt((W316/L316)/(W318/L318)))
where R324 stands for the resistance of the resistor 324, W316 stands for the channel width of the NMOS transistor 316, L316 stands for the channel length of the NMOS transistor 316, W318 stands for the channel width of the NMOS transistor 318, and L318 stands for the channel length of the NMOS transistor 318. Since the transconductance of the NMOS transistor 316 and the current flowing thereacross are constant, the bias at the node 306 is constant and independent of variation of the supply voltage.

Referring to FIGS. 3A and 3B, a graph 326 shows how the reference resistance of the sensing circuit 300 remains fixed as the supply voltage varies in accordance with one embodiment of the present invention. A set of curves 328 represent the voltages at the node 312 with various supply voltages. As the supply voltage decreases, the sense voltage at the node 312 decreases, too. A set of curves 330 represent the relations between the resistance of the electrical fuse 302 and the sense output at the output line 312 with various supply voltages. Any given curve of the set 330 includes a logic “0” region, logic “1” region, and a reference resistance region, which is the segment of the curve connecting the upper and lower horizontal lines. The reference resistance represents a benchmark for determining if the electrical fuse 302 is programmed. If the resistance of the electrical fuse 302 is higher than the reference resistance, the sensing circuit 300 outputs logic “1,” or vice versa.

As shown in graph 326, the reference resistance of the sensing circuit 300 remains in a substantially fixed range irrespective of the variation of the supply voltage. This avoids the issue that the sensing circuit 300 misreads the electrical fuse 302 due to the variation of the supply voltage VDD. No matter how the supply voltage varies, the bias applied to the gate of the NMOS transistor 304 remains constant. In this embodiment, the reference resistance is set about 1 k ohm.

Furthermore, the sensing circuit 300 is independent of variation of fabrication process. The transconductance gm1 of the NMOS transistor 316 is independent of its threshold voltage, which is particular susceptible to a process variation. The bias at the node 306 is therefore substantially free from the influence of the process variation.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A sensing circuit for sensing a programming state of an electrical fuse, comprising:
an electrical fuse coupled to a first voltage;
a first transistor serially coupled between the electrical fuse and a second voltage that is lower than the first voltage;
an inverter sense amplifier coupled to a node between the electrical fuse and the first transistor for outputting a logic signal whose value is determined based on a comparison between a resistance of the electrical fuse and a predetermined reference resistance; and
a bias circuit for applying a bias independent of variation of the first voltage to a gate of the first transistor, such that the predetermined reference resistance does not change substantially due to the variation of the first voltage.

2. The sensing circuit of claim 1 wherein the first transistor is an NMOS transistor.

3. The sensing circuit of claim 1 wherein the bias circuit further comprises a first PMOS transistor coupled to the first voltage.

4. The sensing circuit of claim 3 wherein the bias circuit further comprises a second NMOS transistor serially coupled between the first PMOS transistor and the second voltage.

5. The sensing circuit of claim 4 wherein the bias circuit further comprises a second PMOS transistor coupled to the first voltage having its gate connected to its drain and to the gate of the first PMOS transistor.

6. The sensing circuit of claim 5 wherein the bias circuit further comprises a third NMOS transistor serially coupled to the second PMOS transistor, having its gate connected to a gate and drain of the second NMOS transistor.

7. The sensing circuit of claim 6 wherein the bias circuit further comprises a resistor serially coupled between the third NMOS transistor and the second voltage.

8. The sensing circuit of claim 7 wherein the gate of the first transistor is connected to an output node between the first PMOS transistor and the second NMOS transistor.

9. The sensing circuit of claim 8 wherein the second NMOS transistor has a transconductance value determined by characteristics of the second NMOS transistor, third NMOS transistor and the resistor.

10. The sensing circuit of claim 9 wherein the second NMOS transistor has a substantially constant current flowing therethrough, such that a potential of the output node is substantially constant and independent from variation of the first voltage.

11. The sensing circuit of claim 1 wherein the predetermined reference resistance is between about 1 k ohms.

12. A bias circuit for generating a substantially constant bias utilized in a sense circuit that senses a programming state of an electrical fuse, comprising:
a first PMOS transistor coupled to the supply voltage;
a first NMOS transistor serially coupled between the first PMOS transistor and ground;
a second PMOS transistor coupled to the supply voltage having its gate connected to its drain and to a gate of the first PMOS transistor;
a second NMOS transistor serially coupled to the second PMOS transistor, having its gate connected to a gate and drain of the second NMOS transistor; and
a resistor serially coupled between the second NMOS transistor and ground, such that the bias at a node between the first PMOS transistor and the first NMOS transistor is substantially constant, independent of variation of the supply voltage.

13. The sensing circuit of claim 12 wherein the first NMOS transistor has a transconductance value determined by characteristics of the first NMOS transistor, second NMOS transistor and the resistor.

14. The sensing circuit of claim 13 wherein the first NMOS transistor has a substantially constant current flowing therethrough.

15. A sensing circuit for sensing a programming state of an electrical fuse, comprising:
an electrical fuse coupled to a first voltage;
a first transistor serially coupled between the electrical fuse and a second voltage that is lower than the first voltage;
an inverter sense amplifier coupled to a node between the electrical fuse and the first transistor for outputting a logic signal whose value is determined based on a comparison between a resistance of the electrical fuse and a predetermined reference resistance;
a first PMOS transistor coupled to the first voltage;
a second NMOS transistor serially coupled between the first PMOS transistor and the second voltage;
a second PMOS transistor coupled to the first voltage having its gate connected to its drain and to a gate of the first PMOS transistor; and
a third NMOS transistor serially coupled to the second PMOS transistor, having its gate connected to a gate and drain of the second NMOS transistor; and
a resistor serially coupled between the third NMOS transistor and the second voltage,
wherein an output node between the first PMOS transistor and the second NMOS transistor connected to a gate of the first transistor has a substantially constant potential independent of variation of the first voltage, such that the predetermined reference resistance does not change substantially due to the variation of the first voltage.

16. The sensing circuit of claim 15 wherein the first transistor is an NMOS transistor.

17. The sensing circuit of claim 15 wherein the second NMOS transistor has a transconductance value determined by characteristics of the second NMOS transistor, third NMOS transistor and the resistor.

18. The sensing circuit of claim 17 wherein the second NMOS transistor has a substantially constant current flowing therethrough.

19. The sensing circuit of claim 15 wherein the predetermined reference resistance is between about 1 k ohms.
